(19) United States
(12) Patent Application Publication
(10) Pub. No.: US 2024/0388040 A1
(43) Pub. Date: Nov. 21, 2024

(54) ELECTRICAL CONNECTOR CONTACT ASSEMBLY HAVING TWIN-AX CABLES INTERCONNECTED BETWEEN A ROW OF MATING CONTACT PORTIONS AND A ROW OF MOUNTING CONTACT PORTIONS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: AN-JEN YANG, Irvine, CA (US); Terrance F. Little, Fullerton, CA (US); Patrick R. Casher, San Jose, CA (US); Haozhe Zi, Irvine, CA (US)

(21) Appl. No.: 18/665,860

(22) Filed: May 16, 2024

Related U.S. Application Data
(60) Provisional application No. 63/503,150, filed on May 18, 2023.

(51) Int. Cl. H01R 13/6461; H01R 12/71; H01R 13/405; H01R 43/02; H01R 43/20

(52) U.S. Cl. CPC H01R 13/6461; H01R 13/405; H01R 12/716; H01R 43/02; H01R 43/20

(57) ABSTRACT

A contact assembly for an electrical connector, includes: a row of mating contact portions and a first insulator retaining the row of mating contact portions; a row of mounting contact portions and a second insulator retaining the row of mounting contact portions; and plural twin-ax cables interconnected between the row of mating contact portions and the row of mounting contact portions.

### CROSS REFERENCE TO RELATED APPLICATION

This application claims priority to and benefit of U.S. Provisional Patent Application No. 63/503,150, filed May 18, 2023.

### BACKGROUND OF THE INVENTION

### 1. Field of the Invention

The present invention relates to a contact assembly for an electrical connector, comprising a row of mating contact portions, a row of mounting contact portions, and a plurality of twin-ax cables interconnected between the row of mating contact portions and the row of mounting contact portions.

### 2. Description of Related Arts

U.S. Pat. No. 9,774,144 discloses an electrical connector module having a twin-ax cable, first and second contact tails attached to respective ends of first and second conductive elements of the cable, and first and second mating contact portions attached to respective opposite ends of the first and second conductive elements.

U.S. Pat. No. 10,381,767 discloses an electrical connector assembly including a corrugated plate that is shaped to make contact with tails of ground contacts thereof. The corrugated plate provides shielding in the vicinity of tails of signal contacts for radiation emanating from or incident on signal wires of cables from an upper direction and a similar corrugated plate may be attached from below, effectively providing shielding on both sides of the signal wires and the signal contact tails.

### SUMMARY OF THE INVENTION

A contact assembly for an electrical connector, comprises: a row of mating contact portions and a first insulator retaining the row of mating contact portions; a row of mounting contact portions and a second insulator retaining the row of mounting contact portions; and a plurality of twin-ax cables interconnected between the row of mating contact portions and the row of mounting contact portions.

A contact assembly for an electrical connector, comprises: upper and lower rows of mating contact portions and a first insulator retaining the upper and lower rows of mating contact portions; a first row of mounting contact portions and a second insulator retaining the first row of mounting contact portions; a second row of mounting contact portions and a third insulator retaining the second row of mounting contact portions; an upper row of twin-ax cables interconnected between the upper row of mating contact portions and the first row of mounting contact portions; and a lower row of twin-ax cables interconnected between the lower row of mating contact portions and the second row of mounting contact portions.

A method of making a contact assembly comprises the steps of: retaining a row of mating contact portions with a first insulator; retaining a row of mounting contact portions with a second insulator; and interconnecting a plurality of twin-ax cables between the row of mating contact portions and the row of mounting contact portions.

### BRIEF DESCRIPTION OF DRAWINGS

FIG. 1 is a perspective view of an electrical connector incorporating a contact assembly in accordance with the present invention;

FIG. 2 is a view similar to FIG. 1 but from another perspective;

FIG. 3 is an exploded view of the electrical connector;

FIG. 4 is a further exploded view of FIG. 3;

FIG. 5 is a view similar to FIG. 4 but from another perspective;

FIG. 6 is an exploded view of a part of the electrical connector in FIG. 4;

FIG. 7 is a perspective view of the contact assembly;

FIG. 8 is an enlarged view showing a plurality of twin-ax cables connected to a row of mating contact portions;

FIG. 9 is an enlarged view showing the plurality of twin-ax cables connected to a row of mounting contact portions;

FIG. 10 is a view similar to FIG. 7 but from another perspective;

FIG. 11 is a further exploded view of FIG. 7;

FIG. 12 is a side view of FIG. 7;

FIG. 13 is a further exploded view of FIG. 12;

FIG. 14 is a rear view of FIG. 7;

FIG. 15 is a view showing first and second ground bars together wrapping around respective ends of the plurality of twin-ax cables; and

FIG. 16 is a view showing a pair of side plates engaging respective ends of first and second insulators.

### DETAILED DESCRIPTION OF THE DRAWINGS

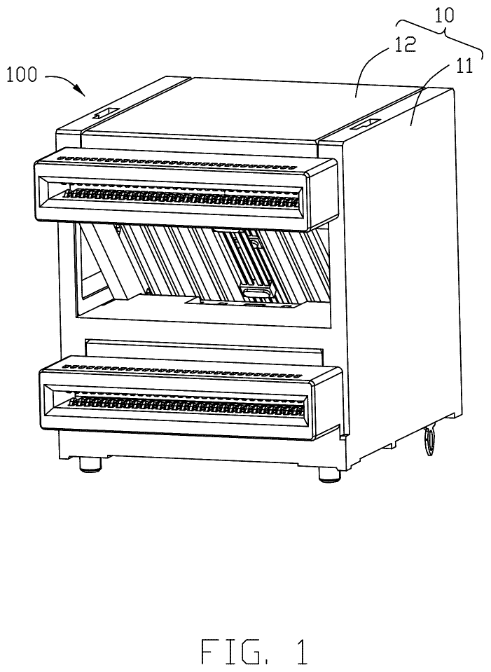

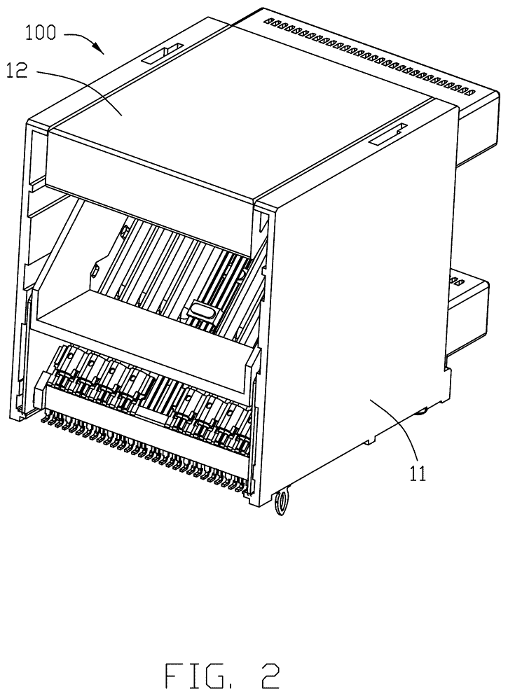

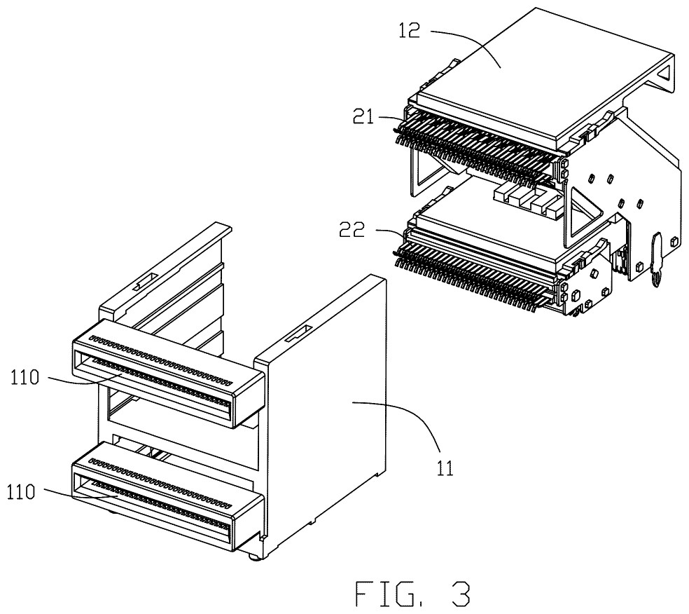

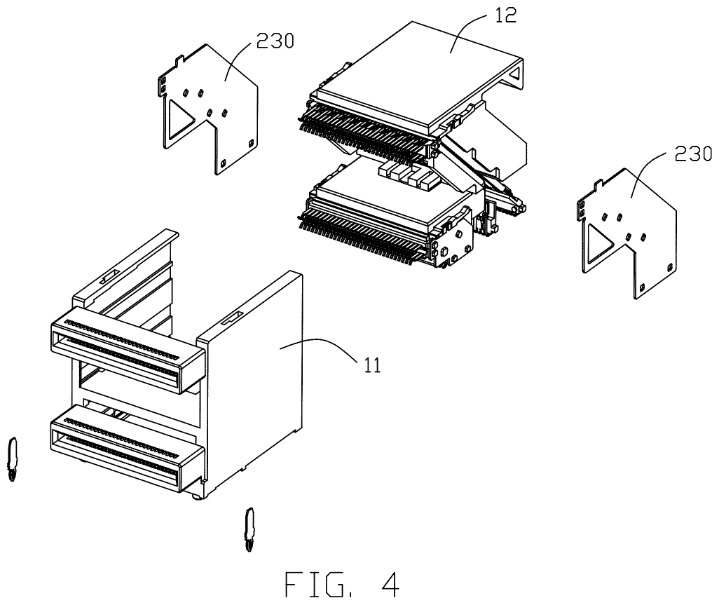

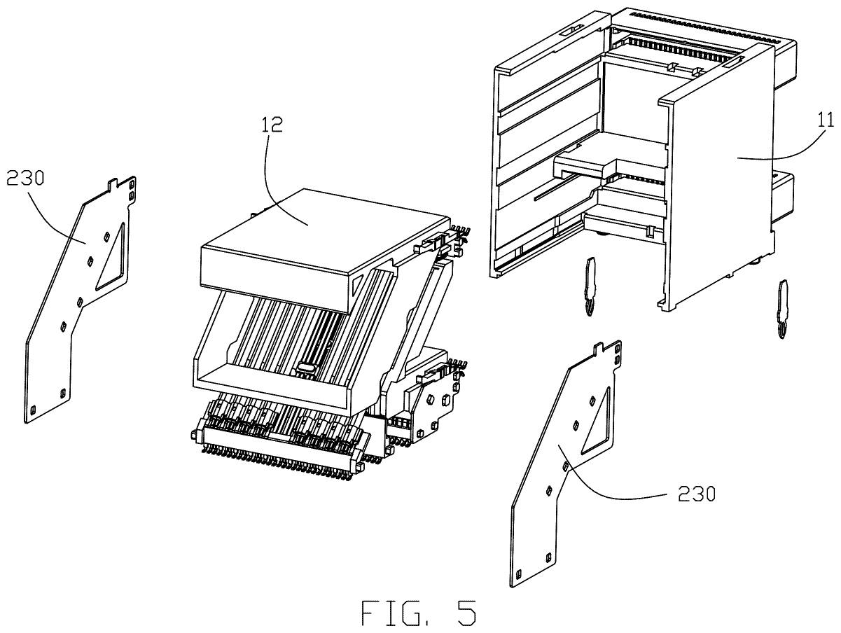

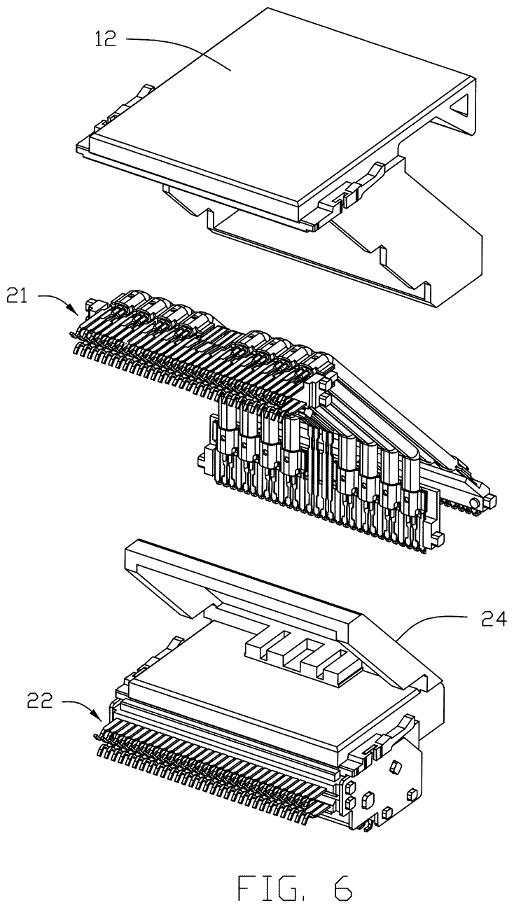

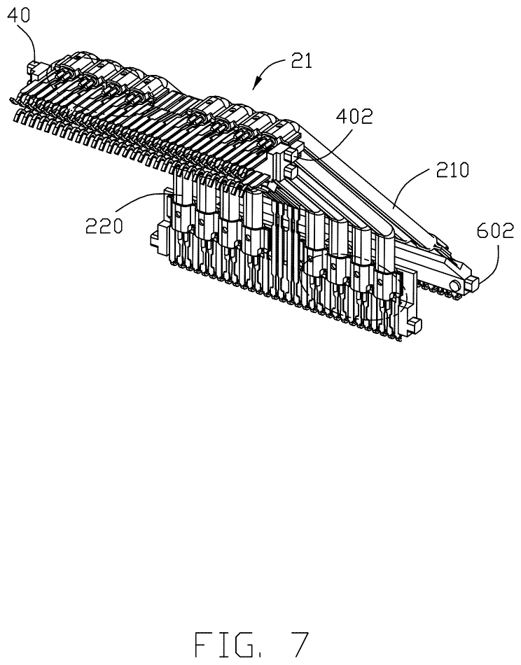

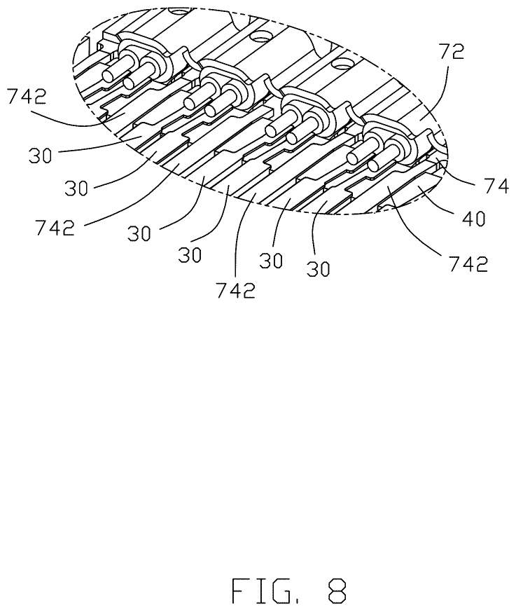

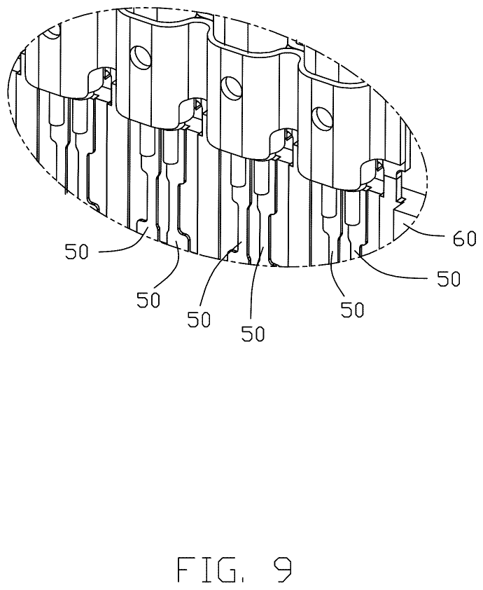

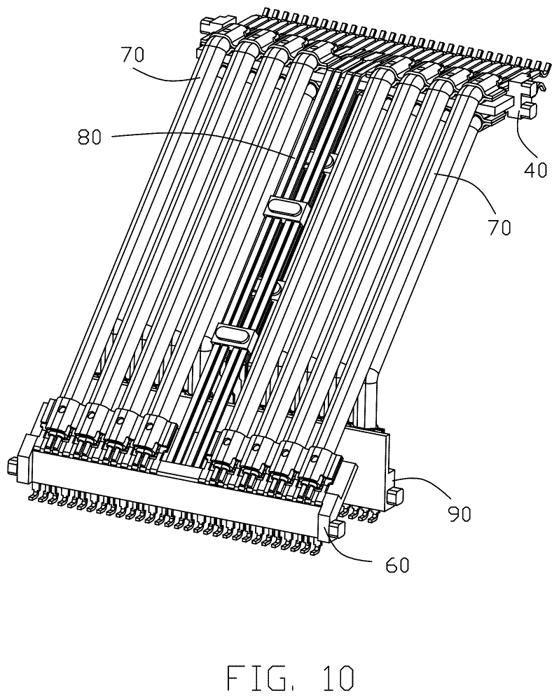

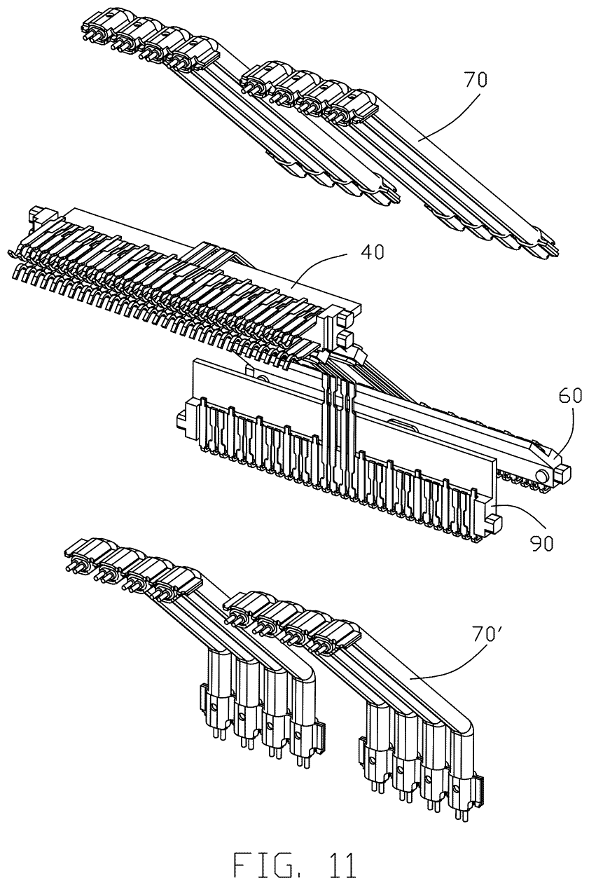

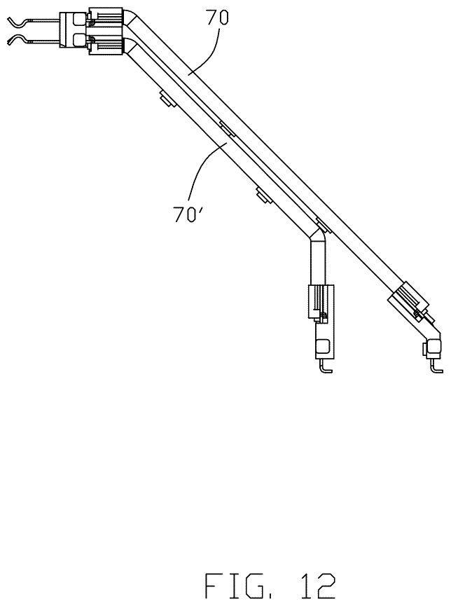

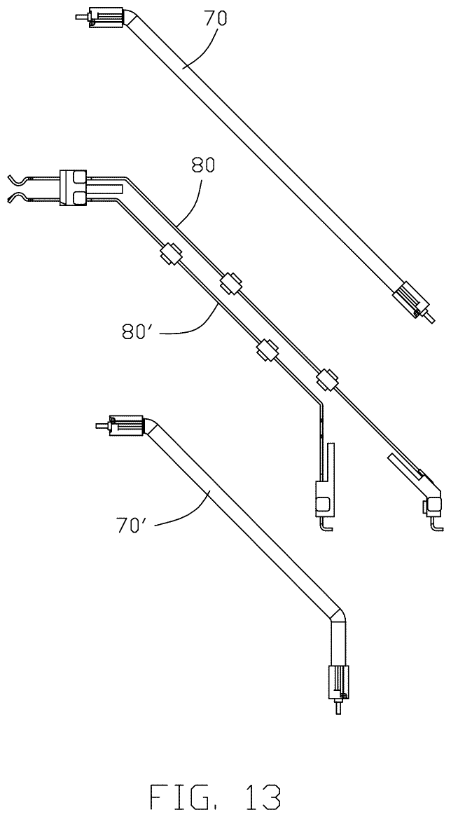

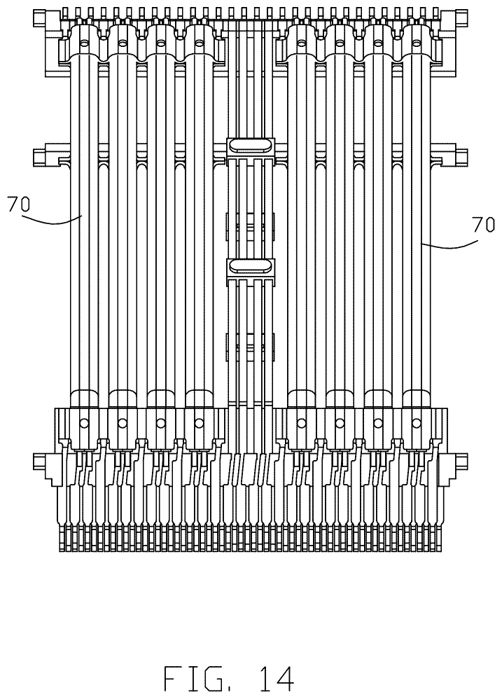

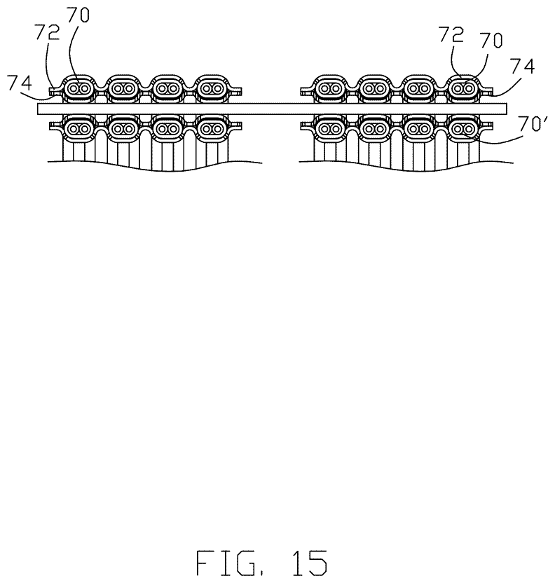

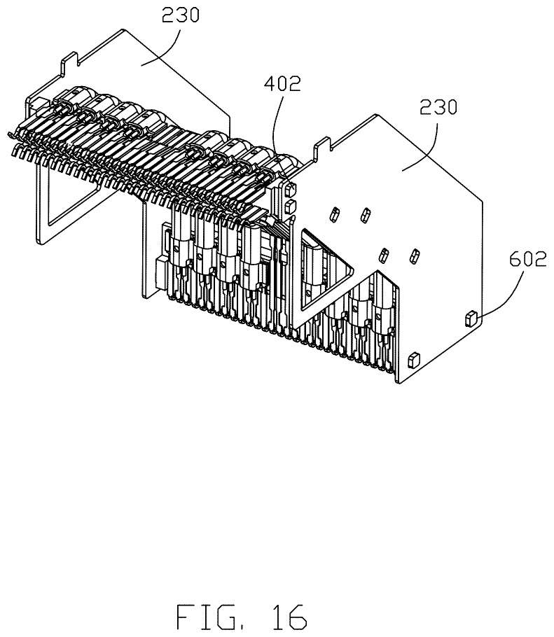

Referring to FIGS. 1-16, an electrical connector 100 comprises an insulative housing 10 and a contact module in the insulative housing 10. The insulative housing 10 includes a main body 11 and a cover 12. The main body 11 has upper and lower mating ports 110.

The contact module in the embodiment shown includes an upper unit 21 corresponding to the upper mating port, a lower unit 22 corresponding to the lower mating port, and a separator 24 therebetween. The upper unit 21 includes an upper assembly 210 and a lower assembly 220. The upper unit 21 may further include a pair of side plates 230 for assembling the upper and lower assemblies 210 and 220. The separator 240 has an opening for circulation of air. The cover 12 has a slot. The side plate 230 has a protrusion for engaging a corresponding slot of the cover 12 so as to combine the upper and lower assemblies 210 and 220 and the cover 12 together.

The upper assembly 210 includes a row of mating contact portions 30 and a first insulator 40 retaining the row of mating contact portions 30, a row of mounting contact portions 50 and a second insulator 60 retaining the row of mounting contact portions 50, and a plurality of twin-ax cables 70 interconnected between the row of mating contact portions 30 and the row of mounting contact portions 50. The mating contact portions 30 are used for mating with a mating connector, and the mounting contact portions 30 are used for mounting to an external circuit board. The cable 70 has a first end and a second end and may be 31 AWG drainless twin-ax cable. As for taping of the raw cable, both aluminum foil and copper foil may be used as shielding layer of the cable, though the latter is preferred for better conductivity and have lower cost. Each cable 70 has first and second conductors extending from the first end to the second end and a cable insulator disposed around the first and second conductors.

The upper assembly 210 may further include a first ground bar 72 and a second ground bar 74 together wrapping around respective ends of the cables 70. Each of the first ground bar 72 and the second ground bar 74 include a plurality of raised portions and flat portions connecting adjacent raised portions. The shape of the raised portion matches the shape of the cable. The raised portions of the first common ground bar 72 and the second ground bar 74 are combined together to wrap around the exposed area of copper foil of the cable and contact with the metal foil. Specifically, laser welding or soldering to join the raised portion of at least one of the first ground bar 72 and the second ground bar 74 with cable's metal foil to ensure better connection. The second ground bar 74 may be retained to the first insulator and have a plurality of ground contact portions 742 alternately interposed in the row of mating contact portions 30. As one example of attaching the cables 70 together with the ground bars 72 and 74 to the mating contact portions 30, firstly the row of mating contact portions 30 and the plurality of ground contact portions 742 may both be insert molded with the first insulator 40, the cables 70 are soldered to the mating contact portions 30, and then the first ground bar 72 is laser welded to the second ground bar 74. If desired, the plurality of ground contact portions 742 alternately interposed in the row of mating contact portions 30 may be not integral with the second ground bar 74. Instead, the ground contact portions 742 may be shaped same as the mating contact portions 30 and laser welded to the second ground bar 74. In such design, as another example of attaching, the first and second ground bar 72 and 74 may attach to the cables 70 first, then the cables 70 are soldered to the mating contact portions 30 and the second ground bar 74 is welded to the ground contact portions 742. The cables 70 may be attached to the mounting contact portions 50 in a similar manner through corresponding first and second ground bars. Wrapping around feature to join the ground bar 72, 74 with cable together may improve cross talk.

The upper assembly 210 may include side-band contacts 80 of known construction for control, power, and low-speed signals, while the cables 70 and the contact portions 30 and 50 are for differential pair signals. The side-band contacts 80 may be insert molded together with the first and second insulators 40 and 60 and have corresponding mating contact portions and mounting contact portions, and connecting portions therebetween. The mating contacts portion of the side-band contacts 80 are disposed in the middle area, and the mating contact portion 30 for transmitting differential pair signals are divided into two groups and disposed on two sides of the mating contact portion of the side-band contact. If needed, the mating contact portions and the mounting contact portions of the side-band contact 80 can also be connected with a cable. The lower assembly 220 may be constructed in a similar manner as the upper assembly 210. In the embodiment shown, the upper assembly 210 and the lower assembly 220 share same first insulator 40 but the lower assembly 220 has a corresponding second insulator 90. As can be understood, the first insulator 40 may be constructed of two components; the second insulator 60 and the second insulator 90 may be parts of an integral component as well.

In the present invention, using twin-ax drainless cable to replace upper port's long trace contacts improves SI, such as better loss and cross talk performance. With cable traces to replace the long trace contacts, large shielding ground plate can also be avoided in order to improve thermal performance.

The lower unit 22 may be constructed in a similar manner as the upper unit 21 and include corresponding cables 70′ and side-band contacts 80′. Each of the first and second insulators 40 and 60 may have positioning ends 402 and 602 for engaging with corresponding holes of the pair of side plates 230. If desired, the positioning ends may be heat staked after securement in the holes.

1. A contact assembly for an electrical connector, comprising:
a row of mating contact portions and a first insulator retaining the row of mating contact portions;
a row of mounting contact portions and a second insulator retaining the row of mounting contact portions; and
a plurality of twin-ax cables interconnected between the row of mating contact portions and the row of mounting contact portions.

2. The contact assembly as claimed in claim 1, wherein the cable has a first end and a second end and is a 31 AWG drainless twin-ax cable.

3. The contact assembly as claimed in claim 2, wherein each cable has a first conductor and a second conductor extending from the first end to the second end, a cable insulator disposed around the first and second conductors, and a metal foil tape wrapped around the insulator.

4. The contact assembly as claimed in claim 3, wherein the metal foil is aluminum foil or copper foil.

5. The contact assembly as claimed in claim 4, wherein the metal foil is copper foil.

6. The contact assembly as claimed in claim 2, further comprising a first ground bar and a second ground bar together wrapping around respective ends of the plurality of twin-ax cables, and wherein the second ground bar is retained to the first insulator and has a plurality of ground contact portions alternately interposed in the row of mating contact portions.

7. The contact assembly as claimed in claim 6, wherein the plurality of ground contact portions are integrally formed with the second ground bar.

8. The contact assembly as claimed in claim 6, wherein the plurality of ground contact portions are laser welded to the second ground bar.

9. The contact assembly as claimed in claim 6, wherein each of the first ground bar and the second ground bar includes a plurality of raised portions and a plurality of flat portions connecting adjacent raised portions.

10. The contact assembly as claimed in claim 9, wherein the raised portions of the first ground bar and the second ground bar are combined together to wrap around an exposed area of copper foil of the cables and contact with the metal foil.

11. The contact assembly as claimed in claim 10, wherein the raised portion of at least one of the first ground bar and the second ground bar is connected to the metal foil of the cable by laser welding or soldering.

12. The contact assembly as claimed in claim 6, further including a plurality of side-band contacts having corresponding mating contact portions and mounting contact portions, and wherein the mating contact portions and mounting contact portions are insert molded with the first insulators and second insulators.

13. The contact assembly as claimed in claim 1, further comprising a pair of side plates having holes for engaging respective positioning ends of the first and second insulators.

14. The contact assembly as claimed in claim 13, wherein the positioning ends are heat staked after securement in the holes.

15. A contact assembly for an electrical connector, comprising:
upper and lower rows of mating contact portions and a first insulator retaining the upper and lower rows of mating contact portions;
a first row of mounting contact portions and a second insulator retaining the first row of mounting contact portions;
a second row of mounting contact portions and a third insulator retaining the second row of mounting contact portions;
an upper row of twin-ax cables interconnected between the upper row of mating contact portions and the first row of mounting contact portions; and
a lower row of twin-ax cables interconnected between the lower row of mating contact portions and the second row of mounting contact portions.

16. The contact assembly as claimed in claim 15, further comprising a first ground bar and a second ground bar together wrapping around respective ends of the upper row of twin-ax cables, and wherein the second ground bar is retained to the first insulator and has a plurality of ground contact portions alternately interposed in the upper row of mating contact portions.

17. The contact assembly as claimed in claim 15, further comprising a pair of side plates engaging respective ends of the first, second, and third insulators.

18. A method of making a contact assembly, comprising the steps of:
retaining a row of mating contact portions with a first insulator;
retaining a row of mounting contact portions with a second insulator; and
interconnecting a plurality of twin-ax cables between the row of mating contact portions and the row of mounting contact portions.

19. The method as claimed in claim 18, wherein firstly the row of mating contact portions and the plurality of mounting contact portions are insert molded with the first insulator, the cables are soldered to the mating contact portions, and then a first ground bar is laser welded to a second ground bar.

20. The method as claimed in claim 18, wherein a first ground bar and a second ground bar are attached to the cables first, then the cables are soldered to the mating contact portions and the second ground bar is welded to the mounting contact portions.
